(19) United States
(12) Patent Application Publication
(10) Pub. No.: US 2026/0268768 A1
(43) Pub. Date: Sep. 10, 2026

(54) INCREASING PENETRATION RATES OF CONNECTED VEHICLES IN TRAFFIC REGIONS OF INTEREST

(71) Applicants: TOYOTA MOTOR ENGINEERING & MANUFACTURING NORTH AMERICA, INC., PLANO, TX (US); MCMASTER UNIVERSITY, HAMILTON (CA)

(72) Inventors: YASHAR ZEIYNALI FARID, Mountain View, CA (US); HAO YANG, Hamilton (CA); SEYHAN UCAR, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP); MCMASTER UNIVERSITY, HAMILTON (CA)

(21) Appl. No.: 19/075,522

(22) Filed: Mar. 10, 2025

(51) Int. Cl. G08G 1/0967; B60W 30/14; B60W 30/18; B60W 50/00; B60W 60/00; G08G 1/01; G08G 1/0968

(52) U.S. Cl. CPC G08G 1/096725; B60W 30/143; B60W 30/18163; B60W 50/0097; B60W 60/001; G08G 1/0108; G08G 1/0129; G08G 1/0133; G08G 1/0145; G08G 1/096844; B60W 2554/406; B60W 2556/10

(57) ABSTRACT

Systems and methods are provided for increasing penetration rates of connected vehicles in traffic regions of interest. An example method may comprise: (1) determining a target connected vehicle penetration rate for a traffic region to implement a traffic management strategy; (2) determining trips for connected vehicles to achieve the target connected vehicle penetration rate for the traffic region, wherein the determined trips are predicted to bring the connected vehicles to the traffic region within a target time interval; and (3) autonomously controlling the connected vehicles in accordance with the determined trips. Here, determining a respective trip for a respective connected vehicle may comprises at least one of: )a) changing an original departure time for a pre-planned trip of the respective connected vehicle; or (b) changing an original navigation route for the pre-planned trip.

### TECHNICAL FIELD

The present disclosure relates generally to automotive systems and technologies. More particularly, some embodiments relate to increasing penetration rates of connected vehicles in traffic regions of interest.

### DESCRIPTION OF RELATED ART

Various technologies have been designed to implement traffic management strategies through centralized, autonomous control/coordination of connected vehicles. Such “traffic management” technologies can improve traffic efficiency by mitigating traffic congestion and other traffic instabilities. In turn, energy efficiency and traffic safety can also be improved. Traffic management technologies may be implemented as cloud-based systems, roadside infrastructure-based systems, vehicle-based systems, or some combination thereof.

Examples of strategies implemented by traffic management technologies can include strategies to mitigate stop-and-go waves through autonomous control of connected vehicles' longitudinal speeds and accelerations (sometimes referred to herein as “stop-and-go-wave mitigation strategies”). Another traffic management strategy may involve autonomously controlling/coordinating connected vehicles to form a perimeter around a traffic region of interest (e.g., an accident site at an intersection) to strategically reduce the flow of traffic into the traffic region of interest (sometimes referred to herein as a “perimeter control strategy”). As such, the perimeter control strategy can improve traffic efficiency and safety within, and around, the traffic region of interest.

### BRIEF SUMMARY OF THE DISCLOSURE

According to various embodiments of the presently disclosed technology, a method is provided. The method may comprise: (1) determining a target connected vehicle penetration rate for a traffic region to implement a traffic management strategy; (2) determining trips for connected vehicles to achieve the target connected vehicle penetration rate for the traffic region, wherein the determined trips are predicted to bring the connected vehicles to the traffic region within a target time interval; and (3) autonomously controlling the connected vehicles in accordance with the determined trips. Here, determining a respective trip for a respective connected vehicle may comprise at least one of: (a) changing an original departure time for a pre-planned trip of the respective connected vehicle; or (b) changing an original navigation route for the pre-planned trip.

In certain embodiments of the method, changing the original departure time for the pre-planned trip may comprise, where the pre-planned trip with the original departure time is predicted to bring the respective connected vehicle to the traffic region outside the target time interval, changing the original departure time such that the pre-planned trip with the changed departure time is predicted to bring the respective connected vehicle to the traffic region within the target time interval.

In various embodiments of the method, changing the original navigation route for the pre-planned trip may comprise: (i) where the original navigation route did not pass through the traffic region, changing the original navigation route to pass through the traffic region; and (ii) where the original navigation route passed through the traffic region but was predicted to bring the respective connected vehicle to the traffic region outside the target time interval, changing the original navigation route such that the changed navigation route is predicted to bring the respective connected vehicle to the traffic region within the target time interval.

In some embodiments of the method, autonomously controlling the respective connected vehicle in accordance with the respective trip may comprise autonomously controlling speed and lane changes of the respective connected vehicle along the changed navigation route to increase a likelihood of the respective connected vehicle reaching the traffic region within the target time interval.

In certain embodiments of the method, the method may further comprise selecting the respective connected vehicle as one of the connected vehicles based on at least one of: (a) a geographic relationship between the original navigation route and the changed navigation route, (b) a geographic relationship between the original navigation route and the traffic region, or (c) a temporal relationship between the pre-planned trip and the target time interval. Here, selecting the respective connected vehicle as one of the connected vehicles based on the geographic relationship between the original navigation route and the changed navigation route may comprise determining a total distance for the original navigation route is within a threshold distance of a total distance for the changed navigation route. Relatedly, selecting the respective connected vehicle as one of the connected vehicles based on the geographic relationship between the original navigation route and the traffic region may comprise determining at least a portion of the original navigation route is within a threshold distance of the traffic region. Similarly, selecting the respective connected vehicle as one of the connected vehicles based on the temporal relationship between the pre-planned trip and the target time interval may comprise at least one of: (i) determining the target time interval is between the original departure time and an original expected final destination arrival time for the pre-planned trip; (ii) determining an expected total time duration for the original navigation route and an expected total time duration for the changed navigation route deviate less than threshold amount; or (iii) determining the changed departure time and the changed navigation route result in a changed final destination arrival time that deviates less than a threshold amount from the original expected final destination arrival time for the pre-planned trip.

In various embodiments of the method, the method may further comprise determining the traffic region is congested. In some of such embodiments, determining the traffic region is congested may comprise at least one of: (a) analyzing historical traffic conditions for the traffic region to predict the traffic region will be congested within the target time interval; or (b) monitoring real-time traffic event data from the traffic region using at least one of sensor data from vehicles within the traffic region, sensor data from infrastructure adjacent the traffic region, and data from third party applications.

In some embodiments of the method, the method may further comprise determining the target connected vehicle penetration rate by predicting a value for a performance metric for the traffic management strategy with the target connected vehicle penetration rate while accounting for an increase in traffic volume for the traffic region in the target time interval associated with bringing the connected vehicles to the traffic region within the target time interval. In certain of such embodiments, the method may further comprise: (a) predicting a first less optimal value for the performance metric with a higher connected vehicle penetration rate and a larger increase in traffic volume associated with bringing a larger number of connected vehicles to the traffic region within the target time interval; and (b) predicting a second less optimal value for the performance metric with a lower connected vehicle penetration rate and a smaller increase in traffic volume associated with bringing a smaller number of connected vehicles to the traffic region within the target time interval.

In certain embodiments of the method, the traffic management strategy may comprise at least one of: (a) a traffic management strategy to reduce stop-and-go waves within the traffic region within the target time interval; or (b) a traffic management strategy to establish a perimeter around a sub-region of the traffic region to reduce flow of traffic into the sub-region.

In various embodiments of the presently disclosed technology, a system is provided. The system may comprise one or more processors comprising machine-executable instructions, which when executed by the one or more processors, cause the system to: (1) determine a target connected vehicle penetration rate for a traffic region to implement a traffic management strategy; (2) determine trips for connected vehicles to achieve the target connected vehicle penetration rate for the traffic region, wherein the determined trips are predicted to bring the connected vehicles to the traffic region within a target time interval; and (3) autonomously control the connected vehicles in accordance with the determined trips. Here, determining a respective trip for a respective connected vehicle may comprise at least one of: (a) changing an original departure time for a pre-planned trip of the respective connected vehicle; or (b) changing an original navigation route for the pre-planned trip.

In some embodiments of the system, the one or more processors may comprise further machine-readable instructions, which when executed by the one or more processors, cause the system to determine the target connected vehicle penetration rate by predicting a value for a performance metric for the traffic management strategy with the target connected vehicle penetration rate while accounting for an increase in traffic volume for the traffic region in the target time interval associated with bringing the connected vehicles to the traffic region within the target time interval. In some of such embodiments, the one or more processors may comprise further machine-readable instructions, which when executed by the one or more processors, cause the system to predict that the target connected vehicle penetration rate and its associated increase in traffic volume maximize the value for the performance metric over other connected vehicle penetrations rates and the other connected vehicle penetration rates' associated increases in traffic volume. In other of such embodiments, the one or more processors may comprise further machine-readable instructions, which when executed by the one or more processors, cause the system to predict a lower value for the performance metric where the connected vehicles are not brought to the traffic region within the target time interval.

In some embodiments of the presently disclosed technology, a cloud-based system is provided. The clou-based system may comprise one or more processors comprising machine-executable instructions, which when executed by the one or more processors, cause the cloud-based system to: (1) modify pre-planned trips for connected vehicles to achieve a target connected vehicle penetration rate for a traffic region, wherein the modified trips are predicted to bring the connected vehicles to the traffic region within a target time interval while the pre-planned trips were not predicted to bring the connected vehicles to the traffic region within the target time interval; and (2) autonomously control the connected vehicles in accordance with the modified trips.

In some embodiments of the cloud-based system, wherein modifying a respective pre-planned trip for a respective connected vehicle may comprise at least one of: (a) changing an original departure time for the respective pre-planned trip; or (b) changing an original navigation route for the respective pre-planned trip. In certain of such embodiments, changing the original navigation route for the respective pre-planned trip may comprise: (i) where the original navigation route did not pass through the traffic region, changing the original navigation route to pass through the traffic region; and (ii) where the original navigation route passed through the traffic region but was predicted to bring the respective connected vehicle to the traffic region outside the target time interval, change the original navigation route such that the changed navigation route is predicted to bring the respective connected vehicle to the traffic region within the target time interval.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict example embodiments.

FIG. 1 illustrates an example road network over which embodiments of the presently disclosed technology may be implemented.

FIG. 2 illustrates an example vehicle, in accordance with various embodiments of the presently disclosed technology.

FIG. 3 illustrates an example implementation of a penetration rate enhancement system, in accordance with various embodiments of the presently disclosed technology.

FIG. 4 illustrates an example process that may be performed by a penetration rate enhancement system to increase a penetration rate of connected vehicles within a traffic region of interest, in accordance with various embodiments of the presently disclosed technology.

FIG. 5 illustrates an example computing component that may be used to implement various features of embodiments described in the present disclosure.

The figures are not exhaustive and do not limit the present disclosure to the precise form disclosed.

### DETAILED DESCRIPTION

As described above, various technologies have been designed to implement traffic management strategies through centralized, autonomous control/coordination of connected vehicles. Such “traffic management” technologies can improve traffic efficiency by mitigating traffic congestion and other traffic instabilities. In turn, energy efficiency and traffic safety can also be improved.

However, traffic management technologies generally require (or otherwise assume) a minimum “penetration rate” of connected vehicles within a traffic region to effectively implement a traffic management strategy. As used herein, penetration rate (sometimes referred to herein as connected vehicle penetration rate) may refer to a ratio or percentage of vehicles within a traffic region that can be autonomously controlled by a traffic management system. Below the minimum penetration rate, the traffic management system may not have the requisite influence over traffic activity in the traffic region to implement an effective traffic management strategy.

Minimum penetration rate requirements can vary based on traffic region and traffic management strategy. For example, a perimeter control strategy to reduce flow of traffic near an accident site intersection may have a relatively lower minimum penetration rate requirement (e.g., 12%) than a stop-and-go wave mitigation strategy on a congested stretch of highway (e.g., 20%).

A challenge for traffic management technologies is that global penetration rates (i.e., penetration rates across large geographic areas, such as a city or the continental United States) are generally lower than minimum penetration rate requirements for many traffic management strategies. As such, in many cases local penetration rates (i.e., penetration rates within specific traffic regions of interest) are lower than the minimum penetration rates required to effectively implement traffic management strategies. This is due in part to the number of legacy vehicles on the road which are not compatible with, or which otherwise do not facilitate, autonomous control by a centralized traffic management technology. Moreover, certain traffic management technologies may be designed to work with only one (or a subset) of original equipment manufacturers' (OEMs') connected vehicles—further reducing actual/effective penetration rates for these traffic management technologies.

Against this backdrop, the presently disclosed technology provides systems and methods for autonomously controlling connected vehicles to increase local penetration rates within traffic regions of interest to achieve a target/minimum penetration rate for implementing a traffic management strategy. This may involve modifying pre-planned trips of the connected vehicles so that the connected vehicles are present within the traffic region of interest within/across a target time interval- and are thus able to participate in the traffic management strategy. Accordingly, the presently disclosed technology can improve the functioning of a computerized traffic management system that implements the target traffic management strategy, and more generally, improve traffic efficiency and safety.

For example, a system of the presently disclosed technology (e.g., a cloud-based system, a roadside infrastructure-based system, a vehicle-based system, or a combination thereof) can initially determine a target penetration rate for implementing a traffic management strategy within a traffic region. Here, the traffic region may be a congested traffic region, or a traffic region with another identified traffic instability (e.g., an accident, a bottleneck, lane drop, etc.). Examples of the traffic management strategy can include perimeter control strategies, stop-and-go wave mitigation strategies, etc.

In some implementations, the target penetration rate may comprise a minimum penetration rate requirement for implementing the traffic management strategy. This minimum/target penetration rate can be predicted by the system (e.g., through simulation), or may be provided to the system by a third-party application (e.g., a separate computerized traffic management system).

In other implementations, the system can predict the target penetration rate maximizes a value for a performance metric (e.g., a performance metric associated with reducing travel times) for the traffic management strategy within the traffic region. Such a prediction may account for an increase in traffic volume associated with bringing additional connected vehicles to the traffic region to achieve the target penetration rate. In related implementations, the system may more simply predict that the target penetration rate will yield a higher value for the performance metric than a status quo penetration rate for the traffic region if no action is taken by the system. This prediction may also account for an increase in traffic volume associated with bringing additional connected vehicles to the traffic region to achieve the target penetration rate.

After determining the target penetration rate, the system can determine trips for connected vehicles to achieve the target penetration rate for the traffic region.

In some implementations, the system may predict that the determined trips will bring the connected vehicles to the traffic region within a target time interval, or in some more specific implementations, in a staggered manner across the target time interval.

Determining a respective trip for a respective connected vehicle may involve changing an original departure time for a pre-planned trip (e.g., a pre-planned trip to deliver groceries, a pre-planned trip to transport an occupant from home to work, etc.) of the respective connected vehicle. This may increase the likelihood (or otherwise ensure) that the respective connected vehicle reaches the traffic region within the target time interval (or in some more specific implementations, at a particular time within the target time interval). Relatedly, determining the respective trip can also involve changing an original navigation route for the pre-planned trip. For example, the changed navigation route may pass through the traffic region on the way to the pre-planned trip's ultimate destination, where the original navigation route did not. The changed navigation route can also increase the likelihood (or otherwise ensure) that the respective connected vehicle reaches the traffic region within the target time interval (e.g., by taking a shortcut or a slightly slower route).

In some implementations, the system can select the connected vehicles based on temporal or geographic aspects or their pre-planned trips. For example, the system can select a respective connected vehicle based on any one or combination of: (a) a geographic relationship between the traffic region and an original navigation route for the respective connected vehicle's pre-planned trip (e.g., if at least a portion of the original navigation route is within a threshold distance of the traffic region); (b) a geographic relationship between the original navigation route and a changed navigation route (e.g., if a total distance for the original navigation route is within a threshold distance of a total distance for the changed navigation route); and (c) a temporal relationship between the pre-planned trip and the target time interval (e.g., if the target time interval is between the original departure time and an original expected final destination arrival time for the pre-planned trip). The system can also consider other factors when selecting the connected vehicles, such as: (i) flexibility of original departure times for their pre-planned trips; (ii) their capabilities for vehicle communications; (iii) availability of their computing resources; (iv) their compliance rates or statistics associated with participating in past traffic management strategies; (v) availability of incentives for the connected vehicles (or their occupants/owners) when deployed in traffic management strategies; (vi) total pre-planned trip times and distances; (vii) total pre-planned trip energy consumption; etc.

After determining the trips for the connected vehicles to achieve the target penetration rate for the traffic region, the system can autonomously control the connected vehicles in accordance with the determined trips. In some implementations, this may involve autonomously controlling speed and lane changes of a respective connected vehicle along its changed navigation route to increase the likelihood (or otherwise ensure) that the respective connected vehicle reaches the traffic region within the target time interval.

By determining modified trips for, and autonomously controlling the connected vehicles to achieve a target penetration rate for implementing a traffic management strategy within a traffic region of interest, the system can improve the functioning of a computerized traffic management system that implements the traffic management strategy. More generally, the system can improve traffic efficiency and safety within the traffic region, and across a larger road network.

Systems and methods are described in greater detail in conjunction with the following figures.

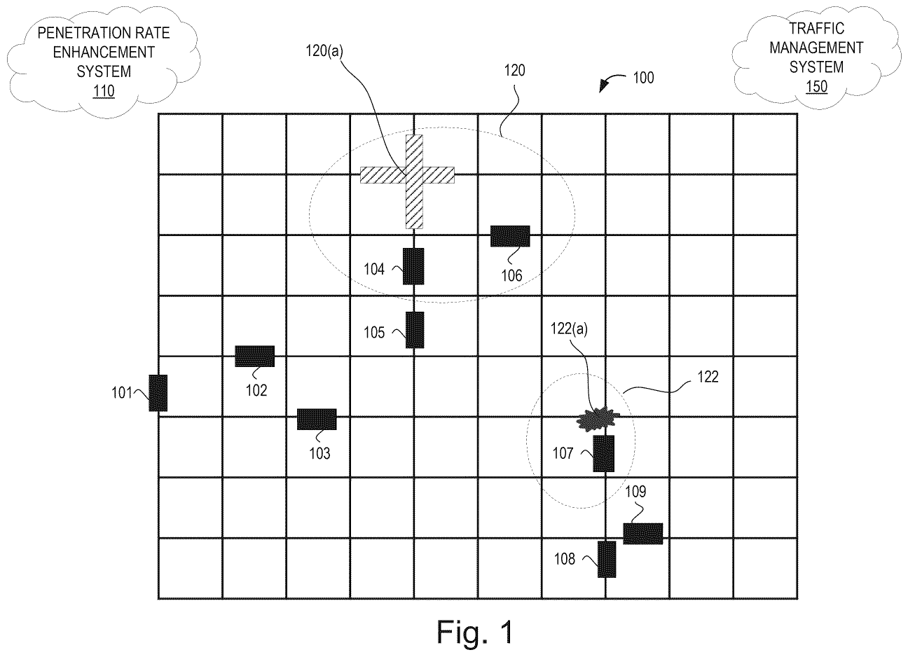

FIG. 1 illustrates an example road network 100 over which embodiments of the presently disclosed technology may be implemented.

For example, a traffic management system 150 (e.g., a cloud-based system, a roadside infrastructure-based system, a vehicle-based system, or a combination thereof) may be configured to reduce traffic congestion on road network 100 by implementing traffic management strategies using connected vehicles—such as connected vehicles 101, 102, 103, 104, 105, 106, 107, 108 and 109. It may be appreciated that while FIG. 1 only depicts connected vehicles 101-109, many other vehicles (including other connected vehicles) may be traveling on road network 100 as well.

As depicted, road network 100 may include two traffic regions of interest (e.g., traffic regions comprising one or more traffic instabilities)—namely traffic region 120 and traffic region 122.

Traffic region 120 may comprise a congested intersection 120(a). Traffic region 122 may include an incident 122(a) such as a traffic accident, a road closure, a local bottleneck, a lane drop, etc.

Accordingly, traffic management system 150 may plan to implement a first traffic management strategy within traffic region 120 (e.g., a stop-and-go wave mitigation strategy). Relatedly, traffic management system 150 may plan to implement a second traffic management strategy within traffic region 122 (e.g., a perimeter control strategy).

However, each traffic management strategy may have a minimum, or more generally, a target penetration rate for desired efficacy. For example, the target penetration rate for the first traffic management strategy may be 15%. The target penetration rate for the second traffic management strategy may be 8%.

Moreover, the status quo penetration rates (i.e., current and predicted penetration rates if no action is taken by penetration rate enhancement system 110) within traffic regions 120 and 122 may be lower than 15% and 8% respectively.

Accordingly, penetration rate enhancement system 110 can support traffic management system 150 by autonomously controlling connected vehicles (e.g., connected vehicles 101-109) within road network 100 to achieve the target penetration rates in traffic regions 120 and 122.

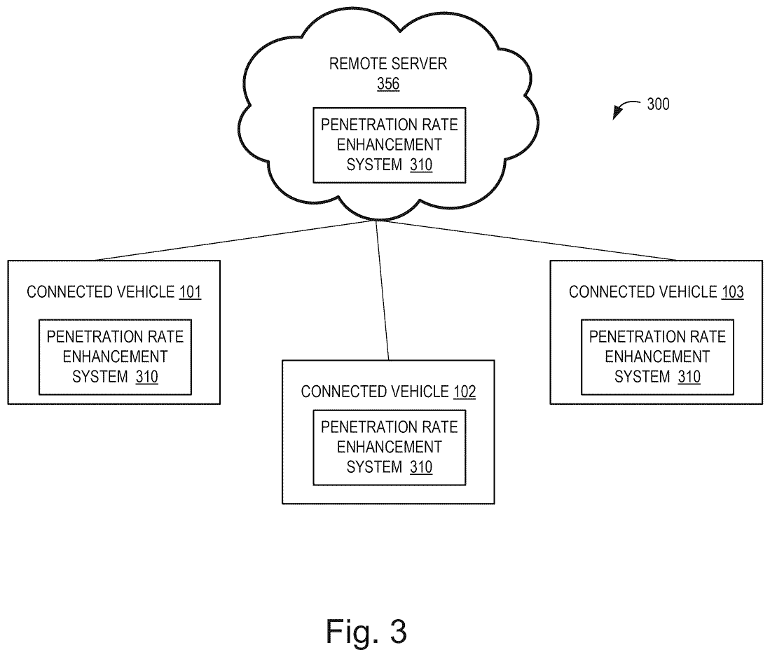

Like traffic management system 150, penetration rate enhancement system 110 may comprise a cloud-based system, a roadside infrastructure-based system, a vehicle-based system, or a combination thereof (see e.g., FIG. 3 for an example). In certain implementations, penetration rate enhancement system 110 may be implemented with traffic management system 150 (e.g., with shared processing, memory, and communication resources). However, in other implementations penetration rate enhancement system 110 and traffic management system 150 may be implemented separately.

Referring again to the use case of FIG. 1, penetration rate enhancement system 110 may determine: (1) the target penetration rate for implementing the first traffic management strategy within traffic region 120 (e.g., 15%); and (2) the target penetration rate for implementing the first traffic management strategy within traffic region 120 (e.g., 8%).

Penetration rate enhancement system 110 can determine these target penetration rates in various ways.

For example, the target penetration rates may be provided by traffic management system 150 in a request to help achieve the target penetration rates within traffic regions 120 and 122 respectively. The request may include: (1) the target penetration rate (e.g., 15%) for the first traffic management strategy that traffic management system 150 plans to implement within traffic region 120; and (2) the target penetration rate (e.g., 8%) for the second traffic management strategy that traffic management system 150 plans to implement within traffic region 122. In some implementations, the request may also include a target time interval through/during which the target penetration rates should be maintained (e.g., between 11:00 am-11:15 am). In certain implementations, penetration rate enhancement system 110 may receive similar requests from traffic management system 150 at scheduled intervals (e.g., every ten minutes).

In some implementations, penetration rate enhancement system 110 can determine the target penetration rates independent from traffic management system 150. For example, penetration rate enhancement system 110 can predict/determine the target penetration rates through simulation, or based on historical data for traffic management strategies.

Related to above, penetration rate enhancement system 110 can also predict how the target penetration rates, along with their associated potential increases in traffic volume resulting from bringing/re-rerouting additional connected vehicles to traffic regions 120 and 122 to achieve the target penetration rates, will impact performance for the first and second traffic management strategies.

For example, penetration rate enhancement system 110 can predict a value for a performance metric (e.g., a value for reduction in travel time) for the first traffic management strategy with its associated target penetration rate (e.g., 15%) while accounting for the potential increase in traffic volume associated with bringing/re-rerouting additional connected vehicles to traffic region 120 (e.g., 3 additional connected vehicles that would not otherwise pass through traffic region 120, or that would not pass through traffic region 120 within the target time interval). In some of these implementations, if penetration rate enhancement system 110 does not predict an improvement (or an improvement over a threshold value) over the status quo penetration rate and traffic volume, penetration rate enhancement system 110 may refrain from autonomously controlling additional connected vehicles to traffic region 120. In certain implementations, penetration rate enhancement system 110 can instead refine/modify the target penetration rate for the first traffic management strategy such that the refined/modified penetration rate (e.g., a slightly lower penetration rate) and its associated increase in traffic volume (e.g., a slightly lower increase) maximize a value of the performance metric for the first traffic management strategy.

Either way, after confirming the target penetration rates (which as discussed above, may be modified under the analysis above) will improve performance for the first and second traffic management strategies, penetration rate enhancement system 110 can select and determine trips for connected vehicles on road network 100 to realize the target penetration rates.

For example, penetration rate enhancement system 110 can select connected vehicles 101, 102, 103 and 105 to bring to traffic region 120 to help implement the first traffic management strategy (as depicted, connected vehicles 104 and 106 may already be within traffic region 120). Relatedly, penetration rate enhancement system 110 can select connected vehicles 108 and 109 to bring to traffic region 122 to help implement the second traffic management strategy (as depicted, connected vehicle 107 may already be within traffic region 122).

Referring specifically to the first traffic management strategy to be implemented within traffic region 120, penetration rate enhancement system 110 can select connected vehicles 101, 102, 103, and 105 based on any one or combination of: (a) geographic relationships between these connected vehicles and traffic region 120; (b) geographic relationships between pre-planned trips/original navigation routes for these connected vehicles and traffic region 120; and (c) temporal relationships between the pre-planned trips/original departure times for these connected vehicles and the target time interval for implementing the first traffic management strategy. Penetration rate enhancement system 110 can also consider other factors when selecting the connected vehicles, such as: (i) flexibility of original departure times for their pre-planned trips; (ii) their capabilities for vehicle communications; (iii) availability of their computing resources; (iv) their compliance rates or statistics associated with participating in past traffic management strategies; (v) availability of incentives for the connected vehicles (or their occupants/owners) when deployed in traffic management strategies; (vi) total pre-planned trip times and distances; (vii) total pre-planned trip energy consumption; etc.

As alluded to above, upon selecting connected vehicles 101, 102, 103 and 105 to bring to traffic region 120, penetration rate enhancement system 110 can next determine trips for these vehicles. This may involve any one or combination of: (1) changing original departure times for pre-planned trips of connected vehicles 101, 102, 103 and 105; and (2) changing original navigation routes for the pre-planned trips of connected vehicles 101, 102, 103 and 105.

For example, penetration rate enhancement system 110 can determine a trip for connected vehicle 101 by changing an original departure time for a pre-planned trip of connected vehicle 101 (e.g., a changing an original departure time for a pre-planned trip to deliver groceries from 11:00 am to 10:50 am). This may increase the likelihood (or otherwise ensure) that connected vehicle 101 reaches traffic region 120 within the target time interval (or in some more specific implementations, at a particular time within the target time interval). Relatedly, determining the trip for connected vehicle 101 can also involve changing an original navigation route for connected vehicle 101's pre-planned trip. For example, the changed navigation route may pass through traffic region 120 on the way to the pre-planned trip's ultimate destination, where the original navigation route did not. The changed navigation route can also increase the likelihood (or otherwise ensure) that connected vehicle 101 reaches traffic region 120 within the target time interval (e.g., by taking a shortcut or a slightly slower route).

After determining the trips for the connected vehicles to achieve the target penetration rates for traffic regions 120 and 122 respectively, penetration rate enhancement system 110 can autonomously control the connected vehicles in accordance with the determined trips. In some implementations, this may involve autonomously controlling speed and lane changes of a respective connected vehicle along its (original or changed) navigation route to increase the likelihood (or otherwise ensure) that the respective connected vehicle reaches its associated traffic region (e.g., traffic region 120 or 122) within a target time interval.

As described above, by determining (modified) trips for, and autonomously controlling connected vehicles 101-109 to achieve the target penetration rates, penetration rate enhancement system 110 can improve the functioning of traffic management system 150 when it implements the first and second traffic management strategies. More generally, penetration rate enhancement system 110 can improve traffic efficiency and safety within the traffic regions 120 and 122, and across the larger road network 100.

While not directly described above, in some implementations, penetration rate enhancement system 110 can identify traffic regions 120 and 122 as traffic regions of interest (e.g., traffic regions comprising one or more traffic instabilities) independent from traffic management system 150. For example, penetration rate enhancement system 110 can identify traffic region 120 as a traffic region of interest by analyzing historical traffic conditions for traffic region 120/road network 100 to predict that traffic region 120 will be congested within the target time interval. In other implementations, penetration rate enhancement system 110 can monitor real-time traffic event data from traffic region 120/road network 100 to identify traffic region 120 as a traffic region of interest. Such real-time traffic event data may be obtained from vehicle sensors, sensors of infrastructure adjacent traffic region 120, third party applications (e.g., traffic management system 150), or some combination thereof.

Related to above, in some implementations penetration rate enhancement system 110 can determine the first and second traffic management strategies for traffic regions 120 and 122 respectively.

In certain implementations (e.g., where there are multiple traffic regions of interest on road network 100), penetration rate enhancement system 110 can route a connected vehicle to multiple traffic regions of interest along their modified/determined trip. For example, penetration rate enhancement system 110 can determine a trip for connected vehicle 101 that brings connected vehicle 101 to traffic region 122 after traffic region 120.

In various implementations (e.g., where traffic management system 150 is planning traffic management strategies within multiple traffic regions), penetration rate enhancement system 110 can estimate an importance for a respective traffic management strategy to be implemented in a respective traffic region. Based on this estimation, penetration rate enhancement system 110 can evaluate or rank the importance of multiple traffic management strategies planned to be implemented across different traffic regions. Based on this evaluation/ranking, penetration rate enhancement system 110 can determine to “route” more connected vehicle resources towards one traffic region over another. For example, penetration rate enhancement system 110 may estimate that the first traffic management strategy to be implemented within traffic region 120 has a higher importance for overall traffic efficiency on road network 100 than the second traffic management strategy to be implemented within traffic region 122. Accordingly, if the number of available connected vehicles is limited, penetration rate enhancement system 110 can determine to divert more connected vehicles to traffic region 120 instead of traffic region 122.

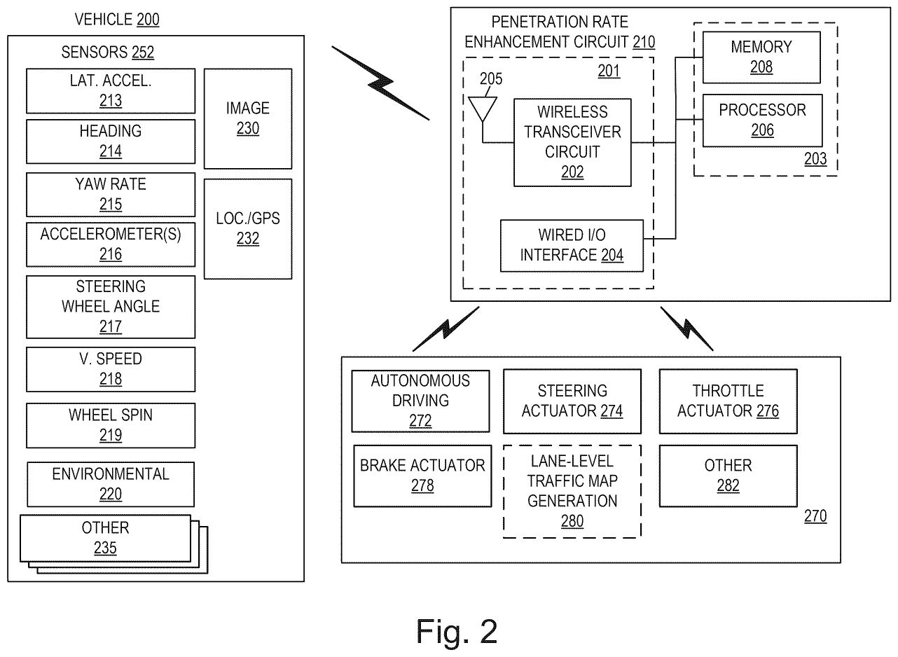

FIG. 2 illustrates an example vehicle 200, in accordance with various embodiments of the presently disclosed technology. Vehicle 200 may be an example of any of the connected vehicles depicted and described in conjunction with FIG. 1.

As depicted, vehicle 200 comprises a penetration rate enhancement circuit 210, sensors 252, and additional vehicle systems 270. Sensors 252 and additional vehicle systems 270 can communicate with penetration rate enhancement circuit 210 via a wired or wireless communication interface. Although sensors 252 and additional vehicle systems 270 are depicted as communicating with penetration rate enhancement circuit 210, they can also communicate with each other. Penetration rate enhancement circuit 210 can be implemented as an electronic control unit (ECU) or as part of an ECU. In other embodiments, penetration rate enhancement circuit 210 can be implemented independently of an ECU.

In the specific example of FIG. 2, penetration rate enhancement circuit 210 includes a communication circuit 201 and a decision circuit 203 (including a processor 206 and a memory 208). Components of penetration rate enhancement circuit 210 are illustrated as communicating with each other via a data bus, although other interfaces can be included.

Processor 206 can include one or more general processing units (GPUs), central processing units (CPUs), microprocessors, or any other suitable processing system. Processor 206 may include a single core processor or multicore processors. Memory 208 can be made up of one or more modules of one or more different types of memory (e.g., flash, RAM, etc.) that may be used to store data related to penetration rate enhancement algorithms, data related to traffic management strategy algorithms, statistical model parameters, instructions and variables for processor 206, as well as any other suitable information.

Although the example of FIG. 2 is illustrated using processor and memory circuitry, in various embodiments decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up penetration rate enhancement circuit 210.

Communication circuit 201 can utilize a wireless transceiver circuit 202 with an associated antenna 205 for wireless communication. Communication circuit 201 can also utilize a wired I/O interface 204 with an associated hardwired data port (not illustrated). As this example illustrates, communications with penetration rate enhancement circuit 210 can include either or both wired and wireless communications. Wireless transceiver circuit 202 can include a transmitter and a receiver to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 205 is coupled to wireless transceiver circuit 202 and can be used by wireless transceiver circuit 202 to transmit radio signals wirelessly to wireless equipment and to receive radio signals as well. These radio signals can include information of almost any sort that is sent or received by penetration rate enhancement circuit 210 to/from other entities such as sensors 252, additional vehicle systems 270, other vehicles, connected roadside infrastructure, cloud computing entities, remote servers, etc.

Wired I/O interface 204 may include a transmitter and a receiver for hardwired communications with other devices. For example, wired I/O interface 204 can provide a hardwired interface to other components, including sensors 252 and additional vehicle systems 270. Wired I/O interface 204 can communicate with other devices using Ethernet or any of a number of other wired communication protocols whether standardized, proprietary, open, point-to-point, networked or otherwise.

In certain implementations, decision circuit 203 and communication circuit 201 may be used for computation, memory, or communication tasks beyond penetration rate enhancement. In some implementations, vehicle 200 may comprise additional processing, memory, or communication resources (not depicted) devoted to these other tasks.

Sensors 252 can include, for example, lateral acceleration sensor(s) 213, heading sensor(s) 214, yaw rate sensor(s) 215, accelerometer(s) 216, steering wheel angle/position sensor(s) 217 (e.g., one or more sensors to detect angle/position of a steering wheel of vehicle 200), and vehicle speed sensor(s) 218 (e.g., one or more sensors to detect speed of vehicle 200). Sensors 252 may also include wheelspin sensor(s) 219 (e.g., one for each wheel), environmental sensor(s) 220 (e.g., to detect salinity or other environmental conditions), image sensor(s) 230, and location sensor(s) 232. Other sensors 235 can also be included as may be appropriate for a given implementation of vehicle 200. For example, other sensors 235 may include proximity sensors such as radar sensors, LiDAR sensors, sonar sensors, etc.

In some embodiments, image sensor(s) 230 may comprise one or more cameras (e.g., monocular cameras, stereoscopic cameras, RGB cameras, infrared cameras, etc.) configured to obtain image data of an environment surrounding vehicle 200.

In certain embodiments, location sensor(s) 232 may comprise a global navigation satellite sensor, a global position sensor, or other types of vehicle positioning sensors. Location sensor(s) 232 may be configured to generate location data for vehicle 200 and/or location data for landmarks in the environment surrounding vehicle 200 (e.g., intersections or corners of a road). The location data may comprise approximate coordinates (e.g., latitude, longitude, and altitude) of vehicle 200's position on the Earth's surface.

In some embodiments, one or more of sensors 252 may include their own processing capability to compute the results for additional information that can be provided to penetration rate enhancement circuit 210. In other embodiments, one or more of sensors 252 may be data-gathering-only sensors that only provide raw data to penetration rate enhancement circuit 210. In further embodiments, one or more hybrid sensors may be included that provide a combination of raw data and processed data to penetration rate enhancement circuit 210. Sensors 252 may provide analog outputs, digital outputs, or a combination of both.

Additional vehicle systems 270 can include any of a number of different vehicle components or subsystems used to control or monitor various aspects of vehicle 200 and its performance. For example, additional vehicle systems 270 may include any one or combination of an autonomous driving system 272, a steering actuator 274, a throttle actuator 276, a brake actuator 278, a lane-level traffic map generation system 280 and other vehicle systems 282. Here other vehicle systems 282 may comprise various other types of vehicle systems utilized in the operation of vehicle 200.

As alluded to above, in certain implementations penetration rate enhancement circuit 210 can send instructions to autonomous driving system 272 to autonomously control vehicle 200 to a traffic region of interest within a target time interval. In other implementations, penetration rate enhancement circuit 210 can send instructions directly to steering actuator 274/throttle actuator 276/brake actuator 278 to autonomously control vehicle 200. In still further implementations, an external penetration rate enhancement system (into which penetration rate enhancement circuit may be incorporated) can send instructions to autonomous driving system 272 or steering actuator 274/throttle actuator 276/brake actuator 278 to autonomously control vehicle 200 in the manner described above.

FIG. 3 depicts an example penetration rate enhancement system 310, in accordance with various embodiments of the presently disclosed technology. Penetration rate enhancement system 310 be an example of penetration rate enhancement system 110 from FIG. 1.

As depicted in FIG. 3, in some embodiments penetration rate enhancement system 310 may be implemented across a remote server 356 (which may have the same/similar architecture as penetration rate enhancement circuit 210) and one or more connected vehicles traversing a road network, such as connected vehicle 101, connected vehicle 102, and connected vehicle 103 from FIG. 1. Such embodiments may be facilitated by a remote environment 300. In some embodiments, remove environment 300 may comprise a cloud-based environment. In other embodiments, remote environment 300 may comprise an edge-based environment. Such an edge-based environment can utilize various types of edge infrastructure, such as roadside/traffic infrastructure, cellular network infrastructure, etc. In some implementations, remote environment 300 may be a combination of a cloud-based environment and an edge-based environment.

Accordingly, penetration rate enhancement system 310 may include separate instances within one or more entities of remote environment 300, such as remote server 356, connected vehicle 101, connected vehicle 102, and connected vehicle 103. In a further aspect, the entities that implement penetration rate enhancement system 310 within remote environment 300 may vary beyond transportation-related devices and encompass roadside infrastructure elements. Thus, the set of entities that function in coordination with remote environment 300 may be varied.

In some embodiments, remote environment 300 itself may comprise a dynamic environment that comprises cloud members that migrate into and out of a geographic area.

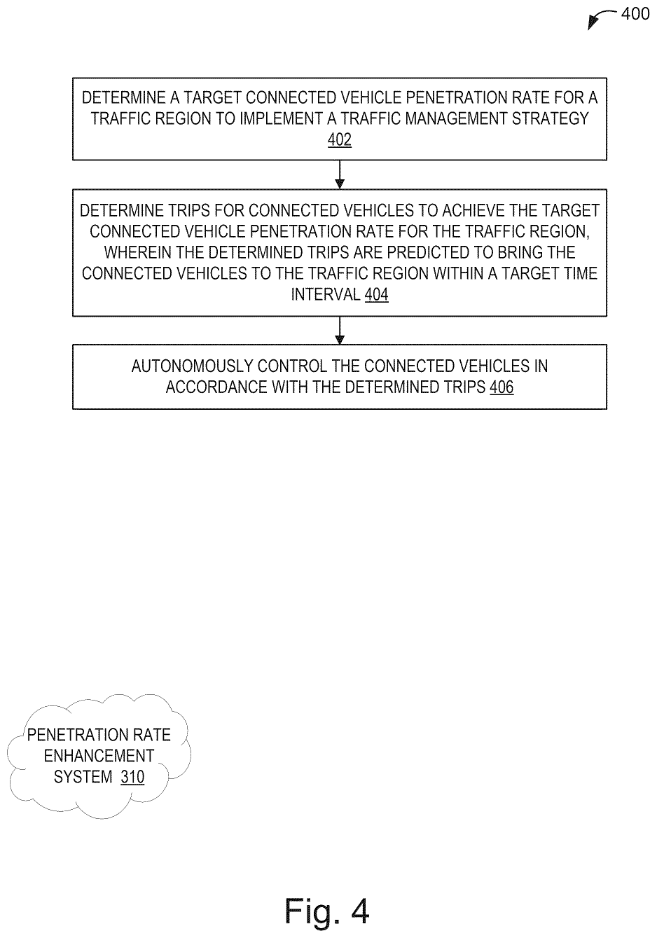

FIG. 4 illustrates an example process that may be performed by penetration rate enhancement system 310 from FIG. 3 to increase a penetration rate of connected vehicles within a traffic region, in accordance with various embodiments of the presently disclosed technology.

As depicted, penetration rate enhancement system 310 can perform operation 402 to determine a target connected vehicle penetration rate for a traffic region to implement a traffic management strategy.

As discussed above, the traffic region may be congested, or may comprise a traffic instability (e.g., a traffic accident, a local bottleneck, a lane drop, etc.).

In some implementations, penetration rate enhancement system 310 can determine that the traffic region is congested, or comprises a traffic instability. Penetration rate enhancement system 310 can make this determination in various ways. For example, penetration rate enhancement system 310 can determine the traffic region is congested by any one or combination of: (a) analyzing historical traffic conditions for the traffic region to predict the traffic region will be congested; or (b) monitoring real-time traffic event data from the traffic region using at least one of sensor data from vehicles within the traffic region, sensor data from infrastructure adjacent the traffic region, and data from third party applications (e.g., a traffic management system such as traffic management system 150 from FIG. 1).

The traffic management strategy may comprise various types of traffic management strategies. For example, in some scenarios the traffic management strategy may comprise a traffic management strategy to reduce stop-and-go waves within the traffic region within a target time interval (i.e., a stop-and-go wave mitigation strategy). In other scenarios, the traffic management strategy may comprise a traffic management strategy to establish a perimeter around a sub-region of the traffic region to reduce flow of traffic into the sub-region (i.e., a perimeter control strategy).

Penetration rate enhancement system 310 can determine the target connected vehicle penetration rate in various ways.

For example, the target connected vehicle penetration rate may be provided by a traffic management system in a request to help achieve the target connected vehicle penetration rate within the traffic region. In some implementations, the request may also include a target time interval through/during which the target connected vehicle penetration rate should be maintained (e.g., between 11:00 am-11:15 am). In certain implementations, penetration rate enhancement system 310 may receive similar requests from the traffic management system at scheduled intervals (e.g., every ten minutes).

In some implementations, penetration rate enhancement system 310 can determine the target connected vehicle penetration rate independent from a separate traffic management system. For example, penetration rate enhancement system 310 can predict/determine the target connected vehicle penetration rate through simulation, or based on historical data for traffic management strategies.

In certain implementations, penetration rate enhancement system 310 can determine the target connected vehicle penetration rate by predicting how the target connected vehicle penetration rate, along with its associated potential increase in traffic volume resulting from bringing/re-rerouting additional connected vehicles to the traffic region to achieve the target connected vehicle penetration rate, will impact performance for the traffic management strategy.

For example, penetration rate enhancement system 310 can predict a value for a performance metric (e.g., a value for reduction in travel time) for the traffic management strategy with its associated target connected vehicle penetration rate while accounting for the potential increase in traffic volume associated with bringing/re-rerouting additional connected vehicles to the traffic region. In some of these implementations, if penetration rate enhancement system 310 does not predict an improvement (or an improvement over a threshold value) over the status quo target connected vehicle penetration rate and traffic volume, penetration rate enhancement system 310 may refrain from autonomously controlling additional connected vehicles to the traffic region. In certain implementations, penetration rate enhancement system 310 can instead refine/modify the target connected vehicle penetration rate such that the refined/modified target connected vehicle penetration rate (e.g., a slightly lower connected vehicle penetration rate) and its associated increase in traffic volume (e.g., a slightly lower increase) maximizes a value of the performance metric for the traffic management strategy.

Either way, after determining the target connected vehicle penetration rate (which as discussed above, may be modified under the analysis above), penetration rate enhancement system 310 can perform operation 404 to determine trips for connected vehicles to achieve the target connected vehicle penetration rate for the traffic region. This may involve predicting the determined trips will bring the connected vehicles to the traffic region within a target time interval.

As discussed above, determining a respective trip for a respective connected vehicle may comprises at least one of: (a) changing an original departure time for a pre-planned trip of the respective connected vehicle; or (b) changing an original navigation route for the pre-planned trip.

For example, changing the original departure time for the pre-planned trip may comprise changing the original departure time such that the pre-planned trip with the changed departure time is predicted to bring the respective connected vehicle to the traffic region within the target time interval-where the pre-planned trip with the original departure time is predicted to bring the respective connected vehicle to the traffic region outside the target time interval.

Changing the original navigation route for the pre-planned trip may comprise: (i) where the original navigation route did not pass through the traffic region, changing the original navigation route to pass through the traffic region; and (ii) where the original navigation route passed through the traffic region but was predicted to bring the respective connected vehicle to the traffic region outside the target time interval, changing the original navigation route such that the changed navigation route is predicted to bring the respective connected vehicle to the traffic region within the target time interval.

In some implementations, penetration rate enhancement system 310 can selecting the respective connected vehicle as one of the connected vehicles based on at least one of: (a) a geographic relationship between its original navigation route and its changed navigation route, (b) a geographic relationship between its original navigation route and the traffic region, or (c) a temporal relationship between its pre-planned trip and the target time interval. For example, selecting the respective connected vehicle as one of the connected vehicles based on the geographic relationship between its original navigation route and its changed navigation route may comprise determining a total distance for its original navigation route is within a threshold distance of a total distance for its changed navigation route. As another example, selecting the respective connected vehicle as one of the connected vehicles based on the geographic relationship between its original navigation route and the traffic region may comprise determining at least a portion of its original navigation route is within a threshold distance of the traffic region. As a third example, selecting the respective connected vehicle as one of the connected vehicles based on the temporal relationship between its pre-planned trip and the target time interval may comprise at least one of: (i) determining the target time interval is between its original departure time and an original expected final destination arrival time for the pre-planned trip; (ii) determining an expected total time duration for its original navigation route and an expected total time duration for its changed navigation route deviate less than threshold amount; or (iii) determining its changed departure time and its changed navigation route result in a changed final destination arrival time that deviates less than a threshold amount from the original expected final destination arrival time for its pre-planned trip.

As depicted, penetration rate enhancement system 310 can perform operation 406 to autonomously control the connected vehicles in accordance with the determined trips. In some implementations, this may involve autonomously controlling speed and lane changes of a respective connected vehicle along its changed navigation route to increase the likelihood of the respective connected vehicle reaching the traffic region within the target time interval.

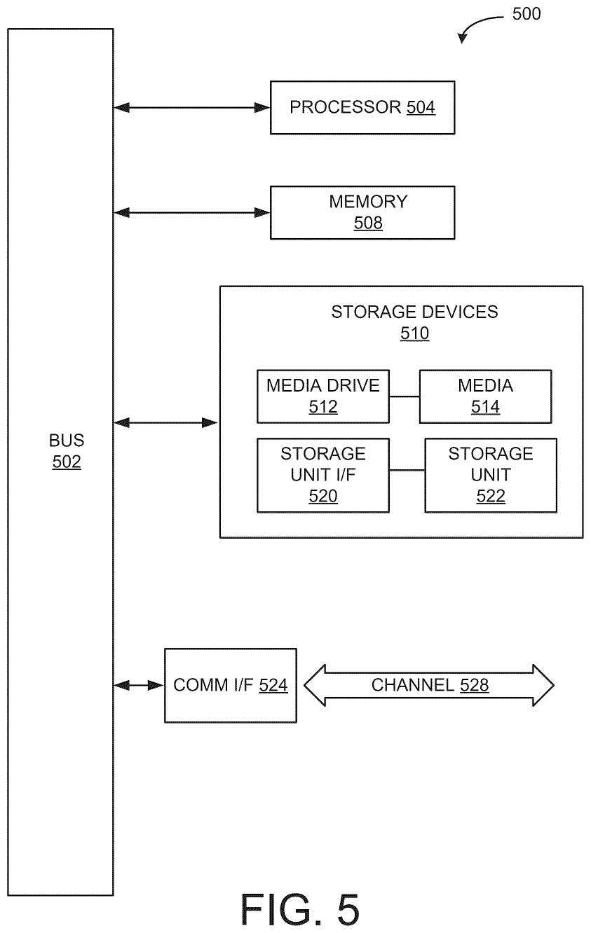

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up a user device, a user system, and a non-decrypting cloud service. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or softmodem, a network interface (such as Ethernet, network interface card, IEEE 802.XX or another interface). Other examples include a communications port (such as for example, a USB port, IR port, RS232 port Bluetooth® interface, or other port), or other communications interfaces. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is target or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method comprising:
determining a target connected vehicle penetration rate for a traffic region to implement a traffic management strategy;
determining trips for connected vehicles to achieve the target connected vehicle penetration rate for the traffic region, wherein the determined trips are predicted to bring the connected vehicles to the traffic region within a target time interval; and
autonomously controlling the connected vehicles in accordance with the determined trips.

2. The method of claim 1, wherein determining a respective trip for a respective connected vehicle comprises at least one of:
changing an original departure time for a pre-planned trip of the respective connected vehicle; or
changing an original navigation route for the pre-planned trip.

3. The method of claim 2, wherein changing the original departure time for the pre-planned trip comprises:
where the pre-planned trip with the original departure time is predicted to bring the respective connected vehicle to the traffic region outside the target time interval, changing the original departure time such that the pre-planned trip with the changed departure time is predicted to bring the respective connected vehicle to the traffic region within the target time interval.

4. The method of claim 2, wherein changing the original navigation route for the pre-planned trip comprises:
where the original navigation route did not pass through the traffic region, changing the original navigation route to pass through the traffic region; and
where the original navigation route passed through the traffic region but was predicted to bring the respective connected vehicle to the traffic region outside the target time interval, changing the original navigation route such that the changed navigation route is predicted to bring the respective connected vehicle to the traffic region within the target time interval.

5. The method of claim 2, wherein autonomously controlling the respective connected vehicle in accordance with the respective trip comprises:
autonomously controlling speed and lane changes of the respective connected vehicle along the changed navigation route to increase a likelihood of the respective connected vehicle reaching the traffic region within the target time interval.

6. The method of claim 2, further comprising:
selecting the respective connected vehicle as one of the connected vehicles based on at least one of:
a geographic relationship between the original navigation route and the changed navigation route,
a geographic relationship between the original navigation route and the traffic region, or
a temporal relationship between the pre-planned trip and the target time interval.

7. The method of claim 6, wherein:
selecting the respective connected vehicle as one of the connected vehicles based on the geographic relationship between the original navigation route and the changed navigation route comprises determining a total distance for the original navigation route is within a threshold distance of a total distance for the changed navigation route; and
selecting the respective connected vehicle as one of the connected vehicles based on the geographic relationship between the original navigation route and the traffic region comprises determining at least a portion of the original navigation route is within a threshold distance of the traffic region.

8. The method of claim 6, wherein selecting the respective connected vehicle as one of the connected vehicles based on the temporal relationship between the pre-planned trip and the target time interval comprises at least one of:
determining the target time interval is between the original departure time and an original expected final destination arrival time for the pre-planned trip;
determining an expected total time duration for the original navigation route and an expected total time duration for the changed navigation route deviate less than threshold amount; or
determining the changed departure time and the changed navigation route result in a changed final destination arrival time that deviates less than a threshold amount from the original expected final destination arrival time for the pre-planned trip.

9. The method of claim 1, further comprising determining the traffic region is congested.

10. The method of claim 9, wherein determining the traffic region is congested comprises at least one of:
analyzing historical traffic conditions for the traffic region to predict the traffic region will be congested within the target time interval; or
monitoring real-time traffic event data from the traffic region using at least one of sensor data from vehicles within the traffic region, sensor data from infrastructure adjacent the traffic region, and data from third party applications.

11. The method of claim 1, further comprising determining the target connected vehicle penetration rate by:
predicting a value for a performance metric for the traffic management strategy with the target connected vehicle penetration rate while accounting for an increase in traffic volume for the traffic region in the target time interval associated with bringing the connected vehicles to the traffic region within the target time interval.

12. The method of claim 11, further comprising:
predicting a first less optimal value for the performance metric with a higher connected vehicle penetration rate and a larger increase in traffic volume associated with bringing a larger number of connected vehicles to the traffic region within the target time interval; and
predicting a second less optimal value for the performance metric with a lower connected vehicle penetration rate and a smaller increase in traffic volume associated with bringing a smaller number of connected vehicles to the traffic region within the target time interval.

13. The method of claim 1, wherein the traffic management strategy comprises at least one of:
a traffic management strategy to reduce stop-and-go waves within the traffic region within the target time interval; or
a traffic management strategy to establish a perimeter around a sub-region of the traffic region to reduce flow of traffic into the sub-region.

14. A system comprising:
one or more processors comprising machine-executable instructions, which when executed by the one or more processors, cause the system to:
determine a target connected vehicle penetration rate for a traffic region to implement a traffic management strategy;
determine trips for connected vehicles to achieve the target connected vehicle penetration rate for the traffic region, wherein the determined trips are predicted to bring the connected vehicles to the traffic region within a target time interval; and
autonomously control the connected vehicles in accordance with the determined trips;
wherein determining a respective trip for a respective connected vehicle comprises at least one of:
changing an original departure time for a pre-planned trip of the respective connected vehicle; or
changing an original navigation route for the pre-planned trip.

15. The system of claim 14, wherein the one or more processors comprise further machine-readable instructions, which when executed by the one or more processors, cause the system to determine the target connected vehicle penetration rate by:
predicting a value for a performance metric for the traffic management strategy with the target connected vehicle penetration rate while accounting for an increase in traffic volume for the traffic region in the target time interval associated with bringing the connected vehicles to the traffic region within the target time interval.

16. The system of claim 15, wherein the one or more processors comprise further machine-readable instructions, which when executed by the one or more processors, cause the system to:
predict that the target connected vehicle penetration rate and its associated increase in traffic volume maximize the value for the performance metric over other connected vehicle penetrations rates and the other connected vehicle penetration rates' associated increases in traffic volume.

17. The system of claim 15, wherein the one or more processors comprise further machine-readable instructions, which when executed by the one or more processors, cause the system to:
predict a lower value for the performance metric where the connected vehicles are not brought to the traffic region within the target time interval.

18. A cloud-based system comprising:
one or more processors comprising machine-executable instructions, which when executed by the one or more processors, cause the cloud-based system to:
modify pre-planned trips for connected vehicles to achieve a target connected vehicle penetration rate for a traffic region, wherein the modified trips are predicted to bring the connected vehicles to the traffic region within a target time interval while the pre-planned trips were not predicted to bring the connected vehicles to the traffic region within the target time interval; and
autonomously control the connected vehicles in accordance with the modified trips.

19. The cloud-based system of claim 18, wherein modifying a respective pre-planned trip for a respective connected vehicle comprises at least one of:
changing an original departure time for the respective pre-planned trip; or
changing an original navigation route for the respective pre-planned trip.

20. The cloud-based system of claim 19, wherein changing the original navigation route for the respective pre-planned trip comprises:
where the original navigation route did not pass through the traffic region, changing the original navigation route to pass through the traffic region; and
where the original navigation route passed through the traffic region but was predicted to bring the respective connected vehicle to the traffic region outside the target time interval, change the original navigation route such that the changed navigation route is predicted to bring the respective connected vehicle to the traffic region within the target time interval.
